(19) United States
(12) Patent Application Publication
(10) Pub. No.: US 2012/0326911 A1
(43) Pub. Date: Dec. 27, 2012

(54) ELECTRICAL DEVICE

(75) Inventors: Shinji NIWA, Nagoya-city (JP); Isao Aichi, Toyota-city (JP)

(73) Assignee: DENSO CORPORATION, Kariya-city (JP)

(21) Appl. No.: 13/532,917

(22) Filed: Jun. 26, 2012

(30) Foreign Application Priority Data
Jun. 27, 2011 (JP) 2011-142071

(51) Int. Cl. G08C 19/12

(52) U.S. Cl. 341/176

(57) ABSTRACT

An electrical device wearable on a body of a user includes a first detector, a second detector, and a mode switch. The first detector detects whether the electrical device is worn on the body. The second detector is mountable on a surface of a first portion of the body and detects whether the first portion is in contact with or separated from a second portion of the body based on whether a closed loop conducting path is formed with the first portion and the second portion. The mode switch switches an operation mode of the electrical device to a lower power consumption mode when the first detector detects that the electrical device is not worn on the body.

### CROSS REFERENCE TO RELATED APPLICATION

This application is based on Japanese Patent Application No. 2011-142071 filed on Jun. 27, 2011, the disclosure of which is incorporated herein by reference.

### TECHNICAL FIELD

The present disclosure relates to an electrical device worn on a user's body when being used.

### BACKGROUND

US 2010/0219989 corresponding to JP-4683148 discloses a ring-shaped control terminal that is worn on a finger of a user when being used. For example, when a tip of an index finger on which the control terminal is worn comes into contact with a tip of a thumb of the same hand as the index finger, a closed loop conducting path is formed. Whether or not the closed loop conducting path is formed is electrically detected, and an apparatus is controlled based on the detection result.

Specifically, the control terminal includes a pair of ring electrodes and a current sensor. The ring electrodes are arranged in parallel in a direction along the axis of the finger. The current sensor is located outside a region enclosed by the electrodes. An alternating-current (AC) signal is applied between the electrodes. When the tip of the index finger comes into contact with the tip of the thumb, an electric current flows to a measurement point at which the current sensor measures the current. In contrast, when the tip of the index finger separates from the tip of the thumb, the current does not flow to the measurement point. Thus, the control terminal can determine whether the tip of the index finger is in contact with or separated from the tip of the thumb based on the current flowing to the measuring point. Then, according to the determination result, the control terminal sends a command to an external target apparatus to control the target apparatus.

It is noted that the control terminal disclosed in US 2010/0219989 cannot be used when the control terminal is not worn on the user's body. If the AC signal is applied to the electrodes under a condition that the control terminal is not worn on the user's body, power is wasted. The unnecessary power consumption may be reduced by adding a power switch to the control terminal. In this case, when the user wears the control terminal, the user turns ON the power switch so that the AC signal can be applied to the electrodes. In contrast, when the user takes off the control terminal, the user turns OFF the power switch so that the AC signal cannot be applied to the electrodes. However, it is a bother for the user to turn ON and OFF the power switch each time the user wears and takes off the control terminal. Further, adding the power switch to the electrical device results in an increase in size of the electrical device.

### SUMMARY

In view of the above, it is an object of the present disclosure to provide a wearable electrical device having a function of automatically detecting whether the electrical device is worn on a user's body to reduce power consumption when the electrical device is not worn on the user's body.

According to an aspect of the present disclosure, an electrical device wearable on a body of a user includes a first detector, a second detector, and a mode switch. The first detector performs a first detection process for detecting whether the electrical device is worn on the body. The second detector is mountable on a surface of a first portion of the body and performs a second detection process for detecting whether the first portion is in contact with or separated from a second portion of the body based on whether a closed loop conducting path is formed with the first portion and the second portion. The mode switch switches an operation mode of the electrical device from a first mode to a second mode when the first detector detects that the electrical device is not worn on the body. A power consumption of the electrical device is less in the second mode than in the first mode.

### BRIEF DESCRIPTION OF THE DRAWINGS

The above and other objects, features and advantages of the present disclosure will become more apparent from the following detailed description made with reference to the accompanying drawings. In the drawings:

FIG. 1A is a diagram illustrating a perspective transparent view of a remote control terminal according to a first embodiment of the present disclosure, and FIG. 1B is a diagram illustrating a finger on which the remote control terminal is worn;

FIG. 2A is a diagram illustrating a cross-sectional view of the remote control terminal, and FIG. 2B is a diagram illustrating a cross-sectional view of the finger on which the remote control terminal is worn;

FIG. 3 is a block diagram of the remote control terminal;

FIG. 4A is a diagram illustrating how to use the remote control terminal, and FIG. 4B is a diagram illustrating a principle of operation of the remote control terminal;

FIG. 5A is a diagram illustrating flow of an electrical signal in a closed loop conducting path, and FIG. 5B is a diagram illustrating an equivalent circuit of a measurement system of the remote control terminal;

FIG. 6 is a flow diagram of an interrupt process performed by a controller of the remote control terminal;

FIG. 7A is a diagram illustrating how to use a remote control terminal according to a modification of the first embodiment, and FIG. 7B is a diagram illustrating a principle of operation of the remote control terminal of FIG. 7A;

FIG. 8 is a block diagram of a remote control terminal according to a second embodiment of the present disclosure;

FIG. 9 is a flow diagram of an interrupt process performed by a controller of the remote control terminal of FIG. 8;

FIG. 10 is a block diagram of a remote control terminal according to a third embodiment of the present disclosure;

FIG. 11 is a flow diagram of an interrupt process performed by a controller of the remote control terminal of FIG. 10;

FIG. 12A is a block diagram of a remote control terminal according to a fourth embodiment of the present disclosure, and FIG. 12B is a diagram of a finger on which the remote control terminal of FIG. 12A is worn; and

FIG. 13A is a block diagram of a remote control terminal according to a fifth embodiment of the present disclosure, and FIG. 13B is a diagram of a finger on which the remote control terminal of FIG. 13A is worn.

### DETAILED DESCRIPTION

### First Embodiment

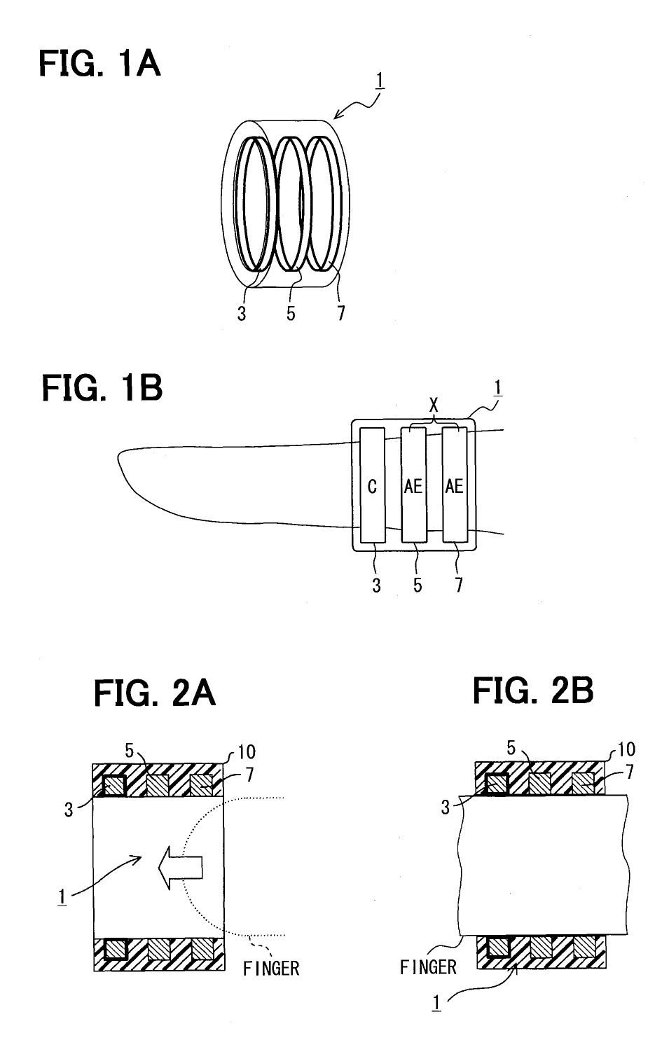

A remote control terminal 1 according to a first embodiment of the present disclosure is described below with reference to FIGS. 1A and 1B. As shown in FIGS. 1A and 1B, the remote control terminal 1 is ring-shaped and wearable on a finger of a user. The remote control terminal 1 includes a ring-shaped toroidal coil 3 and a pair of ring-shaped application electrodes 5 and 7. The toroidal coil 3 and the electrodes 5 and 7 are spaced from each other and arranged in parallel in an axis direction of the finger on which the remote control terminal 1 is worn. Specifically, the toroidal coil 3 is incorporated in the remote control terminal 1 and located outside a region X enclosed by the electrodes 5 and 7.

In an example shown in FIG. 1B, the remote control terminal 1 is worn on the finger in such a manner that the toroidal coil 3 is located closer to a base of the finger than the electrodes 5 and 7. Alternatively, the remote control terminal 1 can be worn on the finger in such a manner that the toroidal coil 3 is located closer to a tip of the finger than the electrodes 5 and 7.

As shown in FIGS. 2A and 2B, the toroidal coil 3 and the electrodes 5 and 7 are held in a ring body 10. The ring body 10 is ring-shaped and defines an outer shape of the remote control terminal 1. The toroidal coil 3, the electrodes 5 and 7, and the ring body 10 are integrated together into the remote control terminal 1. The toroidal coil 3 and the electrodes 5 and 7 are electrically isolated from the ring body 10. An inner surface of each of the electrodes 5 and 7 is exposed to an inner surface of the ring body 10. Thus, when the remote control terminal 1 is worn on the finger, the electrodes 5 and 7 are in contact with the finger.

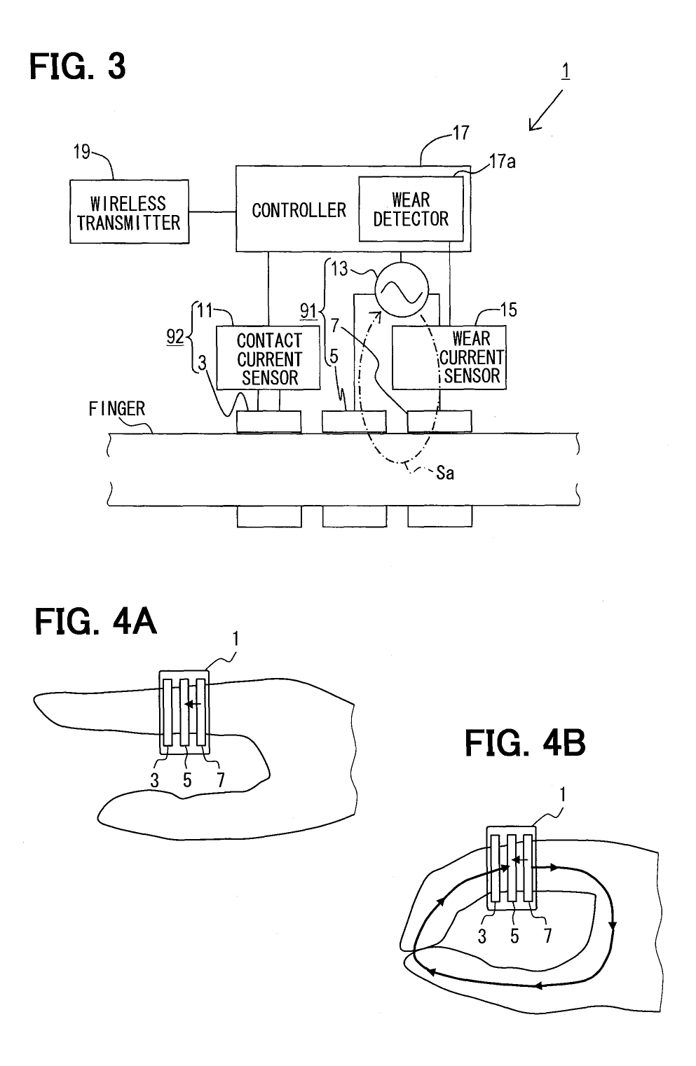

When an alternating-current (AC) signal (voltage) is applied between the electrodes 5 and 7, an electric current flows through the finger inserted through the toroidal coil 3 in the axis direction so that a magnetic field (magnetic flux) can be generated. The toroidal coil 3 measures the electric current by using the magnetic field. Specifically, the toroidal coil 3 is configured as a current transformer having a ring-shaped core (not shown) and a wire (not shown) wound on the core. A voltage is induced across ends of the wire due to electromagnetic induction. The induced voltage is measured by a contact current sensor 11, which is described later with reference to FIG. 3, so that the current flowing through the finger enclosed by the toroidal coil 3 in the axis direction can be measured.

FIG. 3 is a block diagram of the remote control terminal 1. In addition to the toroidal coil 3 and the electrodes 5 and 7, the remote control terminal 1 further includes the contact current sensor 11, an AC source 13, a wear current sensor 15, a controller 17, and a wireless transmitter 19. As described above, the contact current sensor 11 measures the voltage induced across the ends of the wire of the toroidal coil 3. The AC source 13 applies the AC signal between the electrodes 5 and 7. The wear current sensor 15 measures an electric current flowing between the AC source 13 and the electrode 7.

The contact current sensor 11, the AC source 13, the wear current sensor 15, the controller 17, and the wireless transmitter 19 can be located inside the ring body 10. Alternatively, for example, these components can be located outside the ring body 10 and inside an ornament on a surface of the ring body 10. The electrodes 5 and 7 and the AC source 13 are hereinafter sometimes collectively called the “signal application section 91”. The toroidal coil 3 and the contact current sensor 11 are hereinafter sometimes collectively called the “current sensor 92”.

As described above, the current sensor 92 is constricted with the toroidal coil 3. A reason for this is that the AC signal is applied through the electrodes 5 and 7. Alternatively, a direct-current (DC) signal can be applied between the electrodes 5 and 7. In this case, the current sensor 92 can be constricted with a Hall effect device. Specifically, the Hall effect device is placed in a gap of a ring-shaped core, and the current flowing through the finger in the axis direction is measured by measuring a magnetic field applied to the Hall effect device in the gap.

Next, a principle of operation of the remote control terminal 1 is described by considering two cases: the first case, shown in FIG. 4A, where an index finger on which the remote control terminal 1 is worn separates from a thumb of the same hand as the index finger due to motion of a body of the user, and the second case, shown in FIG. 4B, where the index finger on which the remote control terminal 1 is worn comes into contact with the thumb of the same hand as the index finger due to motion of the body of the user.

In the first case shown in FIG. 4A, when the AC signal is applied between the electrodes 5 and 7, the AC signal flows through only a portion of the finger (within the region X shown in FIG. 1B) between the electrodes 5 and 7. Therefore, the current measured by the current sensor 92 is zero.

In contrast, in the second case shown in FIG. 4B, a closed loop conducting path is formed with the index finger, the thumb, and a portion of the body connecting bases of the index finger and the thumb. Thus, the toroidal coil 3 is electrically sandwiched between the electrodes 5 and 7 so that the AC signal can flow through the portion through which the toroidal coil 3 is inserted. As a result, the current (root mean square value or effective value) measured by the current sensor 92 becomes greater than zero. According to the first embodiment, the remote control terminal 1 determines whether the index finger and the thumb come in contact with or separate from each other due to motion of the user's body based on the current detected by the current sensor 92.

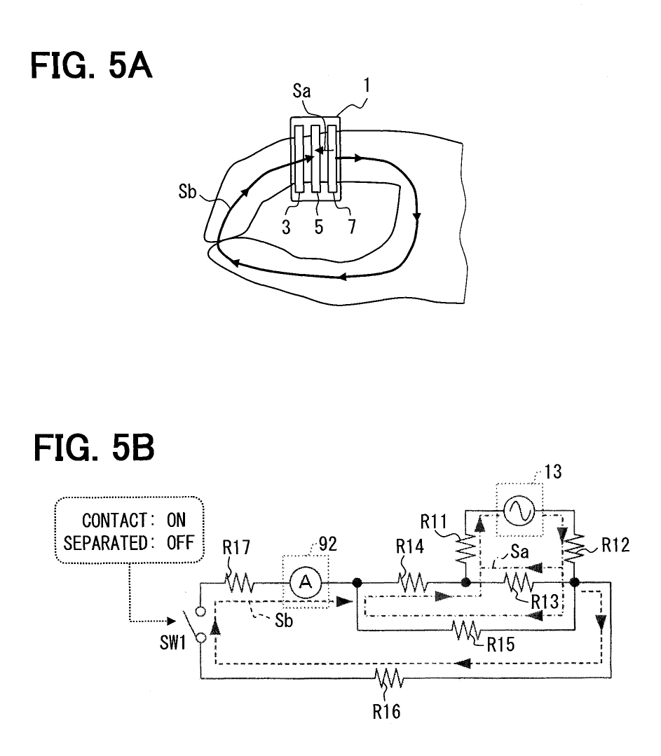

FIGS. 5A and 5B are diagrams of an equivalent circuit of a measurement system of the remote control terminal 1. For the sake of simplicity, in FIGS. 5A and 5B, a resistance of the body portion through which the AC signal applied between the electrodes 5 and 7 flows is represented in a lumped parameter system.

Specifically, a resistor R11 represents a contact resistance between the electrode 5 and the finger. A resistor R12 represents a contact resistance between the electrode 7 and the finger. A resistor R13 represents an electrical resistance of a surface of the body portion within the region X between the electrodes 5 and 7. A resistor R14 represents an electrical resistance of a surface of a body portion from the toroidal coil 3 to the electrode 5.

A resistor R15 represents an electrical resistance of a conducting path that extends inside the body between the electrodes 5 and 7 after bypassing the electrode 5 toward the toroidal coil 3. A resistor R16 represents an electrical resistance of a body portion from the electrode 7 to the tip of the thumb through the base of the index finger. A resistor R17 represents a resistance of a body portion from the tip of the index finger to the toroidal coil 3. A switch SW1 represents a contact and a separation between the index finger and the thumb. An AC power source represents the signal application section 91. An ammeter represents the current sensor 92.

In FIGS. 5A and 5B, an electrical signal Sa flows between the electrodes 5 and 7 regardless of whether the index finger and the thumb are in contact with or separated from each other. In contrast, an electrical signal Sb flows between the electrodes 5 and 7 when the index finger and the thumb are in contact with each other.

As described above, when the index finger on which the remote control terminal 1 is worn comes into contact with and separates from the thumb, the flow of the electrical signal changes so that the current measured by the current sensor 92 can change. The remote control terminal 1 detects the fact that the fingers come into contact with or separate from each other due to motion of the user's body based on the changing current measured by the current sensor 92.

Specifically, the controller 17 causes the AC source 13 to apply the AC signal to the electrodes 5 and 7 and performs a contact determination process for determining whether the index finger is in contact with or separated from the thumb. In the contact determination process, the controller 17 reads the current value measured by the current sensor 92.

The controller 17 has a wear detector 17a. As described above, when the AC signal is applied by the AC source 13 to the electrodes 5 and 7 under a condition that the remote control terminal 1 is worn on the index finger, the signal Sa, shown in FIGS. 3, 5A, and 5B, flows even if the index finger is separated from the thumb. When the AC signal is applied by the AC source 13 to the electrodes 5 and 7, the wear detector 17a reads the current value measured by the wear current sensor 15 and determines whether the remote control terminal 1 is worn on the index finger based on the read current value.

The controller 17 is configured as a microcomputer having a CPU, a ROM, and a RAM. The wear detector 17a can be incorporated in the controller 17. Alternatively, the wear detector 17a can be independent of the controller 17.

The controller 17 sends a command signal through the wireless transmitter 19 to a target apparatus based on the result of the determination by the contact determination process, thereby controlling the target apparatus. The target apparatus is not limited to a specific apparatus, and the command signal can vary according to the target apparatus. For example, the target apparatus can output an image signal to a display apparatus based on the command received from the remote control terminal 1 so that an image showing that the user holds and release an object in virtual space can be displayed on the display apparatus.

The AC source 13 is constant voltage driven or constant current driven and applies the AC signal to the body portion between the electrodes 5 and 7. The AC signal is not limited to s specific waveform. For example, the AC signal can have a triangle waveform, a sinusoidal waveform, a square waveform, or a sawtooth waveform.

The contact current sensor 11 detects the voltage induced in the toroidal coil 3. The contact current sensor 11 is not limited to a specific sensor. For example, the contact current sensor 11 can include an amplifier circuit connected between both ends of the toroidal coil 3 to amplify the voltage across the toroidal coil 3 and a rectifier circuit for rectifying (i.e., converting) an output signal (AC signal) of the amplifier circuit into a DC signal. In this case, an output signal of the rectifier circuit can be converted into a digital value as a current measurement value, and the current measurement value can be inputted to the controller 17. Thus, the root mean square value of the voltage across the toroidal coil 3 can be converted into the root mean square value of the current flowing in the axis direction of the body portion on which the toroidal coil 3 is worn.

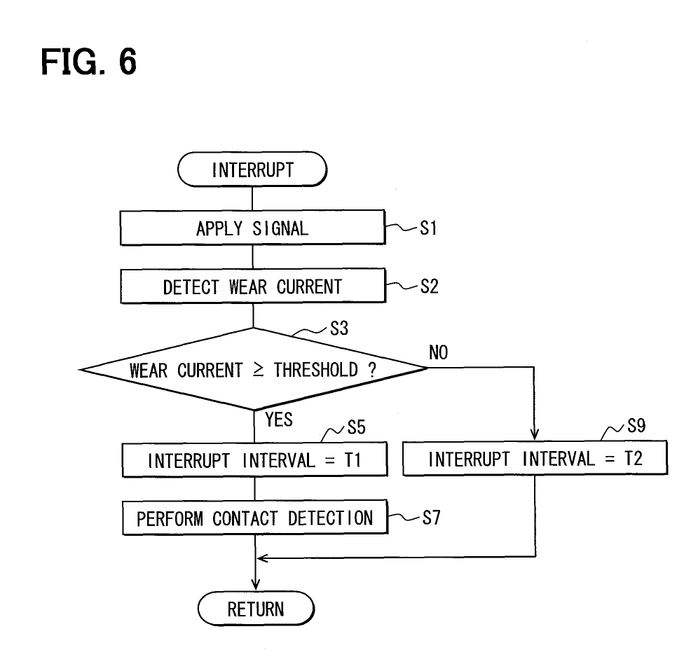

The CPU of the controller 17 regularly performs an interrupt process shown in FIG. 6 based on programs stored in the ROM of the controller 17. S1, S2, and S3 of a flowchart in FIG. 6 correspond to a worn determination process performed by the wear detector 17a.

As shown in FIG. 6, the interrupt process starts at S1, where the controller 17 causes the AC source 13 to apply the AC signal to the electrodes 5 and 7. Then, the interrupt process proceeds to S2, where the controller 17 reads the current value measured by the wear current sensor 15. Then, the interrupt process proceeds to S3, where the controller 17 determines whether the current value read at S2 is equal to or greater than a predetermined threshold value that is set to detect whether the signal Sa flows. If the current value read at S2 is equal to or greater than the predetermined threshold value corresponding to YES at S3, the interrupt process proceeds to S5.

At S5, the controller 17 sets a first interval T1 to an interruption interval at which the controller 17 performs the interrupt process. The first interval T1 is relatively short but long enough to detect the contact and separation between the fingers. Then, the interrupt process proceeds to S7, where the controller 17 performs the contact determination process to determine whether the fingers are in contact with or separated from each other based on the current value measured by the current sensor 92. After S7, the interrupt process is temporally suspended and then restarted when the first interval T1 has elapsed.

In contrast, if the current value read at S2 is less than the threshold value corresponding to NO at S3, the interrupt process proceeds to S9 by skipping S7 (i.e., contact determination process). At S9, the controller 17 sets a second interval T2 to the interruption interval. The second interval T2 is longer than the first interval T1. After S9, the interrupt process is temporally suspended and then restarted when the second interval T2 has elapsed.

As described above, according to the first disclosure, whether or not the remote control terminal is worn on the user is automatically detected (at S3) based on the current value measured by the wear current sensor 15. If the remote control terminal is not worn on the user (corresponding to NO at S3), the controller increases the interrupt interval (at S9) without performing the contact determination process (i.e., S7). Thus, a so-called sleep interval, at which the AC signal is applied and the wear current sensor 15 measures the current, is extended. Therefore, unnecessary power consumption when the remote control terminal 1 is not worn on the user can be reduced.

Further, according to the first disclosure, the worn determination process (i.e., S3) for determining whether the remote control terminal 1 is worn on the user is performed by using the signal application section 91. In such an approach, the remote control terminal 1 can be simplified in configuration and reduced in cost. Further, the worn determination process and the contact determination process (i.e., S7) are performed at the same time during a period where the AC source 13 applies the AC signal to the electrodes 5 and 7. Therefore, the power consumption can be reduced effectively.

In the above example, the tip of the index finger on which the remote control terminal 1 is worn is in contact with and separated from the thumb of the same hand as the index finger. Alternatively, the tip of the index finger can be in contact with and separated from a body portion other then the thumb. For example, the tip of the index finger can be in contact with and separated from a middle finger, a palm of another hand, or a trunk of the body. Even in these cases, the same current change as discussed above occurs near the toroidal coil 3 so that the contact and separation between two body portions can be detected.

Thus, a user can control the target apparatus by using the remote control terminal 1 in such a manner that a tip of a first body portion on which the remote control terminal 1 is worn comes into contact with and separates from a second body portion. It is noted that the tip of the first body portion is located further away from the trunk of the body than the remote control terminal 1.

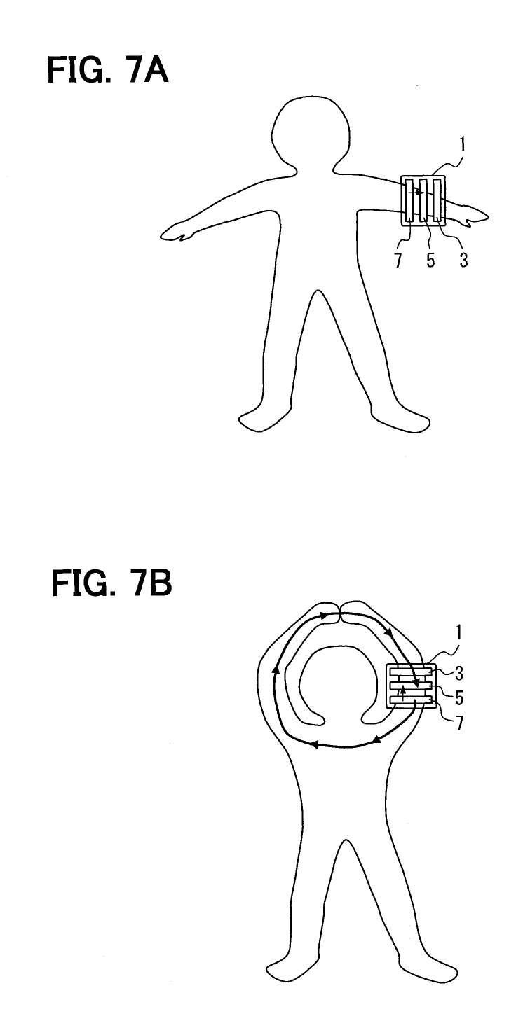

As described above, according to the first embodiment, the remote control terminal 1 is ring-shaped so that the user can wear the remote control terminal 1 on the finger. Alternatively, as shown in FIG. 7A, the remote control terminal 1 can be bracelet-shaped so that the user can wear the remote control terminal 1 on an arm. In this case, as shown in FIG. 7B, when the user holds hands, a closed loop conducting path is formed with the body including the arms so that the current can flow through the conducting path. Therefore, whether or not the user holds hands can be detected based on the current. Thus, the user can control the target apparatus by holding hands together or separating the hands from each other. Alternatively, the use can wear the bracelet-shaped remote control terminal 1 on a leg.

### Second Embodiment

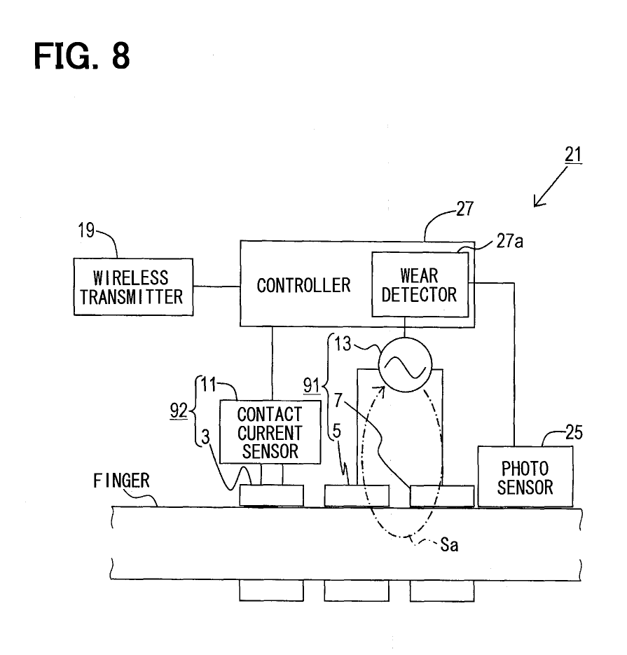

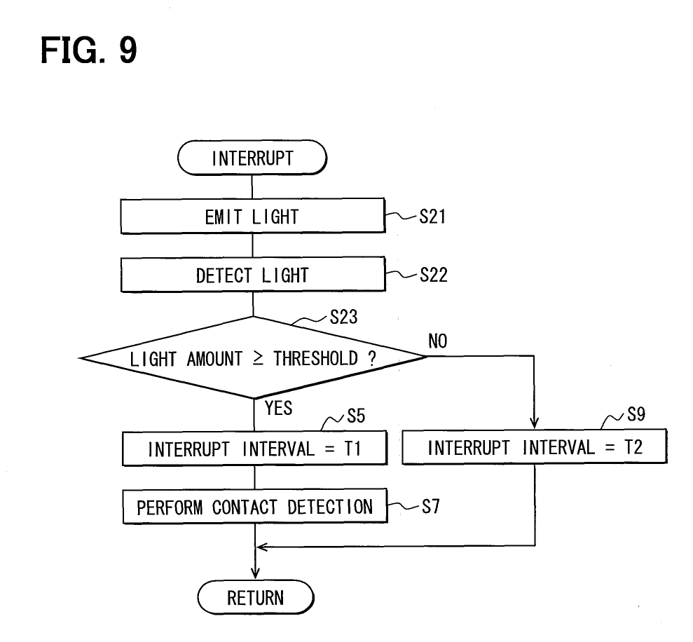

A remote control terminal 21 according to a second embodiment of the present disclosure is described below with reference to FIGS. 8 and 9. A difference of the second embodiment from the first embodiment is as follows. The remote control terminal 21 includes a reflective photo sensor 25 instead of the wear current sensor 15 and a controller 27 instead of the controller 17. The controller 27 has a wear detector 27a instead of the wear detector 17a.

The photo sensor 25 has a light source and a light receiving element. The light source and the light receiving element are located so that they can face a body portion of a user, such as a finger, when the remote control terminal 21 is worn on the finger. That is, the light source and the light receiving element of the photo sensor 25 are located on the center axis side of the toroidal coil 3 and the electrodes 5 and 7. The light source emits light. Assuming that the remote control terminal 21 is worn on the finger, the light receiving element receives light reflected from the finger and outputs a light signal indicative of the amount of received light to the controller 27.

The CPU of the controller 27 regularly performs an interrupt process shown in FIG. 9 based on programs stored in the ROM of the controller 27. S21, S22, and S23 of a flowchart in FIG. 9 correspond to a worn determination process performed by the wear detector 27a.

As shown in FIG. 9, the interrupt process starts at S21, where the controller 17 causes the light source of the photo sensor 25 to emit light. Then, the interrupt process proceeds to S22, where the controller 17 detects the amount of light received by the light receiving element of the photo sensor 25 based on the light signal received from the light receiving element. As mentioned above, when the remote control terminal 21 is worn on the finger, the light emitted from the light source is reflected by the finger so that the amount of light received by the light receiving element can be increased.

Then, the interrupt process proceeds to S23, where the controller 27 determines whether the received light amount detected at S22 is equal to or greater than a predetermined threshold value that is set to detect whether the reflected light is present. If the received light amount detected at S22 is equal to or greater than the predetermined threshold value corresponding to YES at S23, it is determined that the remote control terminal 21 is worn on the user, and the interrupt process proceeds to S5. In contrast, if the received light amount detected at S22 is less than the threshold value corresponding to NO at S23, it is not determined that the remote control terminal 21 is worn on the user, and the interrupt process proceeds to S9.

As describe above, according to the second embodiment, the remote control terminal 21 includes the photo sensor 25 instead of the wear current sensor 15. Even in such an approach, unnecessary power consumption when the remote control terminal 21 is not worn on the user can be reduced. Further, even when the photo sensor 25 is not in close contact with the body, it is possible to detect whether the remote control terminal 21 is worn on the body. Therefore, the detection accuracy can be improved. It is noted that the light source of the photo sensor 25 is not essential. Assuming that the photo sensor 25 has no light source, if the received light amount detected at S22 is equal to or greater than the predetermined threshold value corresponding to YES at S23, it is determined that the remote control terminal 21 is not worn on the user, and the interrupt process proceeds to S9. In contrast, if the received light amount detected at S22 is less than the predetermined threshold value corresponding to YES at S23, it is determined that the remote control terminal 21 is worn on the user, and the interrupt process proceeds to S5. A reason for this is that when the remote control terminal 21 is not worn on the body, it is likely that outside light enters the light receiving element of the photo sensor 25, but when the remote control terminal 21 is worn on the body, it is less likely that outside light enters the light receiving element of the photo sensor 25. In this case, the threshold value is set to detect whether the outside light is present.

### Third Embodiment

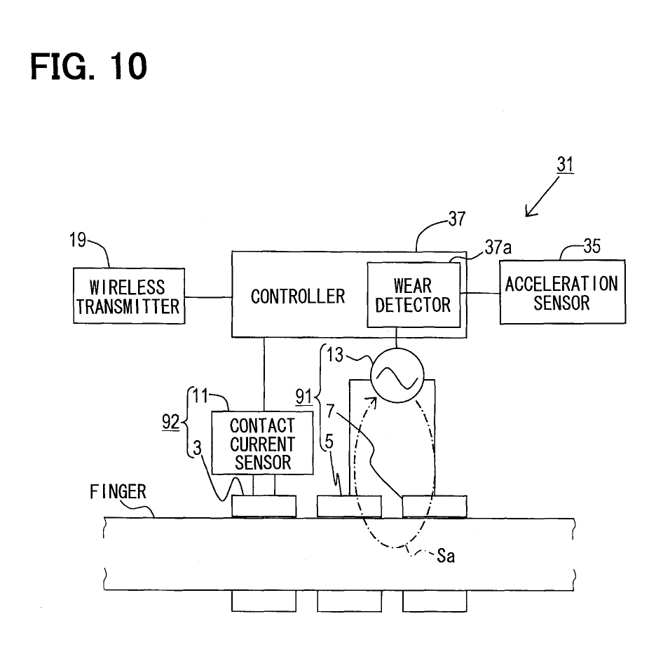

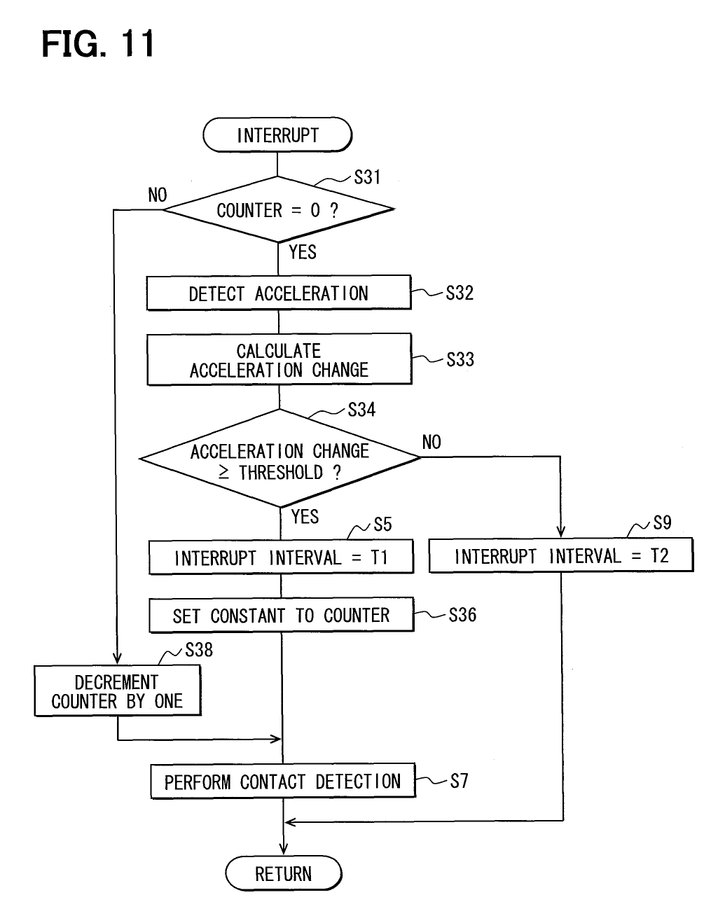

A remote control terminal 31 according to a third embodiment of the present disclosure is described below with reference to FIGS. 10 and 11. A difference of the third embodiment from the first embodiment is as follows. The remote control terminal 31 includes an acceleration sensor 35 instead of the wear current sensor 15 and a controller 37 instead of the controller 37. The controller 37 has a wear detector 37a instead of the wear detector 17a.

The acceleration sensor 35 measures acceleration applied to the remote control terminal 31. When the user wears the remote control terminal 31, the remote control terminal 31 moves with motion of the user so that acceleration can be applied to the remote control terminal 31. Therefore, it is possible to determine whether the remote control terminal 31 is worn on the user based on acceleration applied to the remote control terminal 31.

The CPU of the controller 37 regularly performs an interrupt process shown in FIG. 11 based on programs stored in the ROM of the controller 37. S31, S32, and S33 of a flowchart in FIG. 11 correspond to a worn determination process performed by the wear detector 37a.

As shown in FIG. 11, the interrupt process starts at S31, where the controller 37 determines whether a value of a counter (not shown) is zero. The counter is reset to zero when the controller 37 is initialized. For example, the controller 37 can be initialized when the remote control terminal 31 is powered ON. If the counter value is zero corresponding to YES at S31, the interrupt process proceeds to S32, where the controller 37 measures acceleration applied to the remote control terminal 31 by using the acceleration sensor 35. Then, the interrupt process proceeds to S33, where the controller 37 calculates the amount of change in the acceleration. Then, the interrupt process proceeds to S34, where the controller 37 determines whether the acceleration change amount calculated at S33 is equal to or greater than a predetermined threshold value that is set to detect whether the remote control terminal 31 moves. If the acceleration change amount calculated at S33 is equal to or greater than the predetermined threshold value corresponding to YES at S34, it is determined that the remote control terminal 31 is worn on the user, and the interrupt process proceeds to S5. In contrast, if the acceleration change amount calculated at S33 is less than the predetermined threshold value corresponding to NO at S34, it is not determined that the remote control terminal 31 is worn on the user, and the interrupt process proceeds to S9. As described above, at S34, the acceleration change amount rather than the acceleration is compared with the threshold value. In such an approach, the influence of the acceleration of gravity can be removed.

As can be seen from FIG. 11, according to the third embodiment, S36 is inserted between S5 and S7. At S36, a predetermined constant number is set to the counter in order to prevent the controller 37 from performing S9 immediately when the motion of the user is temporally stopped. The predetermined constant number is a natural number. Therefore, when the acceleration change amount calculated at S33 is equal to or greater than the predetermined threshold value corresponding to YES at S34, the counter value is set to a number greater than zero at S36. In such an approach, at S31 in the next interrupt process, the controller 37 does not determine that the counter value is zero so that the control process can proceed to S38. At S38, the controller 37 causes the counter to decrement by one. After S38, the interrupt process proceeds to S7, where the controller 37 performs the contact determination process.

After S31, S38, and S7 are repeated the constant number of times, the counter becomes zero so that the controller 37 can perform S32, S33, and S34 to determine whether the remote control terminal 31 is worn on the user. Generally, a user relatively often moves a finger. Therefore, a time period necessary to repeat S31, S38, and S7 the constant number of times, i.e., a time period obtained by multiplying the first interval T1 by the constant number can be less than the second interval T2.

As describe above, according to the third embodiment, the remote control terminal 31 includes the acceleration sensor 35 instead of the wear current sensor 15. Even in such an approach, unnecessary power consumption when the remote control terminal 31 is not worn on the user can be reduced. Further, the acceleration sensor 35 can allow the remote control terminal 31 to have a gesture recognition function of detecting motion of fingers without detecting the contact and separation between the fingers.

In the above embodiments, the wear current sensor 15, the photo sensor 25, or the acceleration sensor 35 is used to detect whether the remote control terminal is worn on the user. A structure to detect whether the remote control terminal is worn on the user is not limited to those described in the embodiments. For example, a temperature sensor for detecting a temperature of the body when the temperature sensor comes in contact with the body can be used as a structure to detect whether the remote control terminal is worn on the user. Further, a structure to detect whether the fingers are in contact with or separated from each other can be modified as follows.

### Fourth Embodiment

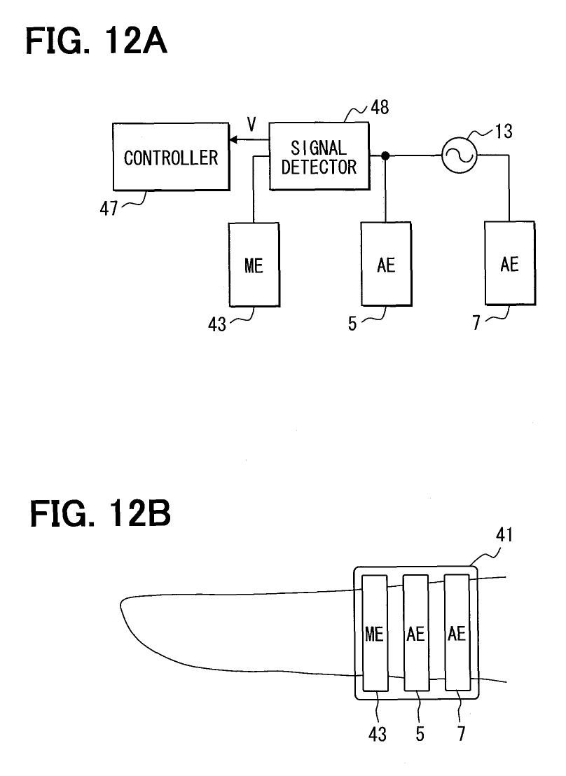

A remote control terminal 41 according to a fourth embodiment of the present disclosure is described below with reference to FIGS. 12A and 12B. A difference of the fourth embodiment from the first embodiment as follows. The remote control terminal 41 has a ring-shaped measurement electrode 43 instead of the toroidal coil 3 and a controller 47 instead of the controller 17.

As shown in FIG. 12B, the electrode 5 is located between the electrode 7 and the measurement electrode 43. That is, the electrode 5 is located closer to the measurement electrode 43 than the electrode 7. As shown in FIG. 12A, the remote control terminal 41 further includes a signal detector 48. The signal detector 48 detects a voltage V between the electrode 5 and the measurement electrode 43 and outputs the detected voltage V to the controller 47. If the detected voltage V is greater than a predetermined threshold Vth, the controller 47 determines that the index finger on which the remote control terminal 41 is worn is in contact with the thumb of the same hand as the index finger. In contrast, if the detected voltage V is equal to or less than the predetermined threshold Vth, the controller 47 determines that the index finger is separated from the thumb. A reason for this is that the detected voltage V is larger when the index finger is in contact with the thumb than when the index finger is separated from the thumb.

Alternatively, the signal detector 48 can measure a phase lag of the AC signal inputted from the measurement electrode 43 with respect to the AC signal applied between the electrodes 5 and 7 based on the voltage (AC signal) between the electrode 5 and the measurement electrode 43. The phase lag is positive in a delay direction. In this case, if the measured phase lag is greater than a predetermined threshold, the controller 47 can determine that the index finger on which the remote control terminal 41 is worn is in contact with the thumb of the same hand as the index finger. In contrast, if the measured phase lag is equal to or less than the predetermined threshold, the controller 47 can determine that the index finger is separated from the thumb.

### Sixth Embodiment

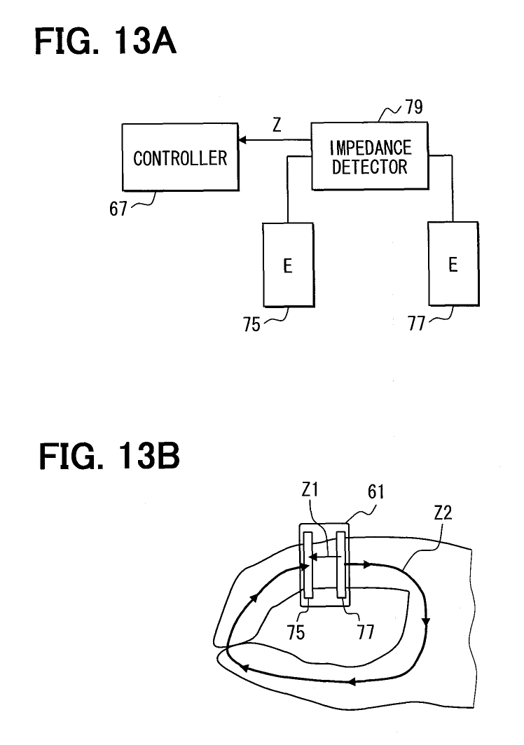

A remote control terminal 61 according to a sixth embodiment of the present disclosure is described below with reference to FIGS. 13A and 13B. A difference of the sixth embodiment from the first embodiment is as follows. The remote control terminal 61 has ring-shaped electrodes 75 and 77 instead of the electrodes 5 and 7 and has a controller 67 instead of the controller 17. It is noted that the remote control terminal 61 does not have the toroidal coil 3.

As shown in FIG. 13A, the remote control terminal 61 has an impedance detector 79. The impedance detector 79 detects an impedance Z between the electrodes 75 and 77 and outputs the detected impedance Z to the controller 67. When the index finger on which the remote control terminal 61 is worn is in contact with the thumb, the detected impedance Z is calculated as follows:

Z=1/(1/Z1+1/Z2)=Z1·Z2/(Z1+Z2)

Z1 represents an impedance of a conducting path extending between the electrodes 75 and 77 without passing a contact point between the index finger and the thumb. Z2 represents an impedance of a conducting path extending between the electrodes 75 and 77 through the contact point between the index finger and the thumb.

In contrast, when the index finger is separated from the thumb, the detected impedance Z is calculated as follows:

Z=Z1

Therefore, the detected impedance Z is smaller when the index finger is in contact with the thumb than when the index finger is separated from the thumb. For this reason, if the detected impedance Z is greater than a predetermined threshold, the controller 67 determines that the index finger on which the remote control terminal 61 is worn is separated from the thumb of the same hand as the index finger. In contrast, if the detected impedance Z is equal to or less than the predetermined threshold, the controller 67 determines that the index finger is in contact with the thumb.

### MODIFICATIONS

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less, or only a single element, are also within the spirit and scope of the present disclosure.

The structure to detect whether the fingers are in contact with or separated from each other is not limited to those described in the embodiments. For example, structures disclosed in US 2010/0219989 or US 2010/0220054 corresponding to JP-2010-282345A can be employed as a structure to detect whether the fingers are in contact with or separated from each other.

In the embodiments, when it is determined that the remote control terminal is not worn on the user, the controller increases the interrupt interval (S9) without performing the contact detection process (S7). Alternatively, when it is determined that the remote control terminal is not worn on the user, the controller can increase the interrupt interval while performing the contact detection process. Alternatively, when it is determined that the remote control terminal is not worn on the user, the controller can be prevented from performing the contact detection process without increasing the interrupt interval. Even in such an approach, the unnecessary power consumption when the remote control terminal is not worn on the user can be reduced. Assuming that the worn determination process (S1-S3) and the contact detection process (S7) are independently performed, an interval of at least one of the worn determination process and the contact detection process can be increased so that the unnecessary power consumption can be reduced.

When it is detected that the remote control terminal is not worn on the user, the remote control terminal can enter a lower power consumption mode, for example, in which an output voltage of the AC source 13 or a pilot lamp of the remote control terminal is turned OFF.

In the embodiments, the controller sends the command signal to the target apparatus by wireless transmission. Alternatively, the controller can send the command signal to the target apparatus by wired transmission.

The correspondence between the terms in the embodiments and claims is as follows. The wear current sensor 15, the wear detector 17a, the steps S1-S3, the photo sensor 25, the wear detector 27a, the steps S21-S23, the acceleration sensor 35, the wear detector 37a, and the steps S31-S34 correspond to a first detector. The signal application section 91 corresponds to a current source. The contact current sensor 11 corresponds to a current sensor. The signal application section 91 and the current sensor 92 correspond to a second detector. The signal detector 48 and the impedance detector 79 also correspond to a second detector. The steps S3, S23, and S34 correspond to a mode switch. The light receiving element of the photo sensor 25 corresponds to a light receiver. The light source of the photo sensor 25 corresponds to a light source. The acceleration sensor 35 corresponds to an acceleration sensor. The wireless transmitter 19 corresponds to a transmitter.

What is claimed is:

1. An electrical device wearable on a body of a user, the electrical device comprising:
a first detector configured to perform a first detection process for detecting whether the electrical device is worn on the body;
a second detector configured to be mounted on a surface of a first portion of the body and perform a second detection process for detecting whether the first portion is in contact with or separated from a second portion of the body based on whether a closed loop conducting path is formed with the first portion and the second portion; and
a mode switch configured to switch an operation mode of the electrical device from a first mode to a second mode when the first detector detects that the electrical device is not worn on the body, wherein
a power consumption of the electrical device is less in the second mode than in the first mode.

2. The electrical device according to claim 1, wherein
the first detector includes a current source configured to apply an electric current to the body and a current sensor configured to detect the current flowing at least partially through the body.

3. The electrical device according to claim 2, wherein
the current source applies the current to the body along the conducting path, and
the second detector performs the second detection process based on whether the current flows through the conducting path.

4. The electrical device according to claim 2, wherein
the first detector includes a light receiver located to face the body when the electrical device is worn on the body, and
the light receiver receives light and outputs a light signal indicative of the amount of the received light.

5. The electrical device according to claim 4, wherein
the first detector further includes a light source configured to emit light toward the body when the electrical device is worn on the body, and
the light receiver receives the light that is emitted from the light source and then reflected from the body.

6. The electrical device according to claim 1, wherein
the first detector includes an acceleration sensor configured to detect acceleration applied to the electrical device.

7. The electrical device according to claim 1, wherein
the mode switch switches the operation mode of the electrical device from the first mode to the second mode by changing at least one of a first interval and a second interval,
the first detector performs the first detection process at the first interval, and
the second detector performs the second detection process at the second interval.

8. The electrical device according to claim 1, wherein
the mode switch switches the operation mode of the electrical device from the first mode to the second mode by preventing the second detector from performing the second detection process.

9. The electrical device according to claim 1, wherein
the first portion is a first finger of one of a right hand and a left hand of the user,
the second portion is a second finger of the one of the right hand and the left hand of the user, and
the electrical device is ring-shaped and wearable on the first finger.

10. The electrical device according to claim 1, further comprising;
a transmitter configured to transmit a control signal to a target objet according to a result of the second detection process performed by the second detector, wherein
the target object is controlled based on the control signal.
